(19) United States
(12) Patent Application Publication
(10) Pub. No.: US 2005/0273825 A1
(43) Pub. Date: Dec. 8, 2005

(54) Media converter with detachable media player

(76) Inventor: Miran Eldeeb, Mountain View, CA (US)

Correspondence Address: FORTUNE LAW GROUP LLP, 100 CENTURY CENTER COURT, SUITE 315, SAN JOSE, CA, 95112, US

(21) Appl. No.: 10/859,655

(22) Filed: Jun. 2, 2004

(51) Int. Cl. H04N 5/445; G06F 13/00; G11B 3/70; H04N 7/18

(52) U.S. Cl. 725/81; 725/37

(57) ABSTRACT

A device for converting multimedia into a digital form includes a main housing having disposed therein a plurality of media readers. Each media reader may have coupled thereto a codec for converting a media format output by each media reader to a digital format. A portable media player having a storage device for storing the converted media may be detachable from the main housing and operable to play the converted media.

### BACKGROUND OF THE INVENTION

The present invention generally relates to media converters and more particularly to a media converter having a detachable media player.

With the proliferation of media formats available to most consumers, the management of these media has become increasingly difficult. For example, many consumers may now have audio media recorded on magnetic tape in the form of audio cassette tapes and on optical disks in the form of CDs. Many consumers also may have video media recorded on video cassettes or on DVDs (digital video discs) and digital photographs stored in memory cards or PC disk drives. While devices are commercially available to play these media formats, a device capable of converting all such media into a digital form and a portable media player capable of playing the converted media is not known in the prior art.

A device capable of reproducing media is disclosed in U.S. Pat. No. 6,693,853 entitled “Reproducing Unit for Recording Medium”. A music-reproducing unit has readers for a plurality of recording mediums including an audio cassette tape, a CD, and an MD (minidisk). The music-reproducing unit does not however convert the format of the reproduced media to a digital format.

An audio recorder and player is disclosed in U.S. Pat. No. 6,076,063 entitled “Audio Player and Recorder Employing Semiconductor Memory as a Recording Medium”. An audio recorder comprises a format converter for extracting a PCM audio signal from data recorded in any one of a variety of formats, a data compressor for encoding the extracted audio signal by a selectable one of a plurality of different methods, and a semiconductor memory for storing the resulting encoded audio signal. An audio player comprises this same semiconductor memory, a data expander for decoding the encoded audio signal stored in the semiconductor memory by a selectable one of a plurality of different methods, and a format converter for converting the decoded audio signal to a selectable one of a variety of formats. While the disclosed device converts audio data and plays the converted audio data, the device is not capable of converting and playing other type of media.

A device for use with an automobile is disclosed in U.S. Pat. No. 6,678,892 entitled “Multimedia Entertainment Unit for use in a Vehicle”. The unit includes an assembly housing adapted to mount against an interior space of the vehicle. A bus is adapted to couple at least one of video and audio signals from each of a plurality of input devices including at least one of a television tuner, a video cassette player, a CD player, a DVD player, and AM/FM radio, and a video game player. At least one display device, houseable in the assembly and operatively coupled to the bus, is adapted to reproduce the video signals. At least one wireless transmitter operatively coupled to the bus is adapted to wirelessly and simultaneously transmit a plurality of audio programs to a plurality of wireless headphone sets. While the disclosed device is capable of coupling a plurality of audio and video devices, the device does not convert the media into a digital format. Nor does the disclosed device provide a portable media player capable of playing the converted media.

In addition to media of the type described above, the Internet, and more particularly the World Wide Web, is increasingly being used for streaming multimedia content including images, audio and video. A conventional streaming server sends multimedia content to a user's computer where the multimedia content is buffered and then output for viewing by the user. The multimedia content is generally stored temporarily on the user's computer and removed once viewing is complete. Devices for decoding and playing multimedia content include QuickTime™ for Apple™ computers and Media Player™ for Windows™ machines. Such devices generally do not provide for storage of the decoded media on the user's computer.

Devices for use in streaming audio content to home entertainment systems are also well known. One such device available from Slim Devices, Inc. of Mountain View, Calif. is the Squeezebox player. Together with a software streaming server running on a personal computer, the player streams audio from a personal computer to a digital stereo over a wireless or Ethernet network. The player includes digital as well as analog audio outputs.

A known device for use in streaming multimedia content to a home entertainment system is available from Hauppauge Computer Works, Inc. of Hauppauge, N.Y. The MediaMVP is a Linux based digital media receiver which includes a hardware MPEG decoder. Music and digital pictures are software decoded by MediaMVP's processor. The device receives the digital media from a personal computer via an Ethernet LAN, decodes the media and outputs video through composite and S-Video connections, and audio through stereo audio output connectors. The device provides an on-television-screen display of media directory listings, receives commands from a remote control, and sends these commands to a personal computer server. Television menus are created on the personal computer server, sent over the LAN and displayed by a device browser.

As can be seen, there is a need in the art for a device capable of converting multimedia into a digital form and a portable media player capable of playing the converted media.

### SUMMARY OF THE INVENTION

In accordance with one aspect of the invention, a device for converting multimedia into a digital form includes a main housing having disposed therein a plurality of media readers. Each media reader may have coupled thereto a codec for converting a media format output by each media reader to a digital format. A portable media player having a storage device for storing the converted media may be detachable from the main housing and operable to play the converted media.

In another aspect of the invention, a device for converting multimedia into a digital form includes a main housing having disposed therein a plurality of media readers and a network interface operable to receive streaming multimedia. Each media reader and network interface may have coupled thereto a codec for converting a media format output by each media reader to a digital format. A portable media player having a storage device for storing the converted media may be detachable from the main housing and operable to play the converted media.

In yet another aspect of the invention, a device for converting media into a digital form includes a media converter including a media reader, a processing circuit coupled to the media reader, the processing circuit including a codec, and a storage device coupled to the media reader.

In yet another aspect of the invention, a device for converting media into a digital form includes a housing, a media reader disposed in the housing, a processing circuit coupled to the media reader and disposed in the housing, the processing circuit including a codec, a storage device coupled to the media reader, the storage device disposed in the housing, and a detachable media player coupled to the housing.

These and other features, aspects and advantages of the present invention will become better understood with reference to the following drawings, description and claims.

### BRIEF DESCRIPTION OF THE DRAWINGS

FIG. 1 is a schematic representation of a device in accordance with the present invention;

FIG. 2 is a block diagram of a media converter in accordance with the present invention; and

FIG. 3 is a block diagram of a detachable media player in accordance with the present invention.

### DETAILED DESCRIPTION OF THE INVENTION

The following detailed description is of the best modes of carrying out the invention. The description is not to be taken in a limiting sense, but is made merely for the purpose of illustrating the general principles of the invention, since the scope of the invention is best defined by the appended claims.

The present invention generally provides a device for converting multimedia into a digital form including a main housing having disposed therein a plurality of media readers. Each media reader may have coupled thereto a codec for converting a media format output by each media reader to a digital format. A portable media player having a storage device for storing the converted media may be detachable from the main housing and operable to play the converted media.

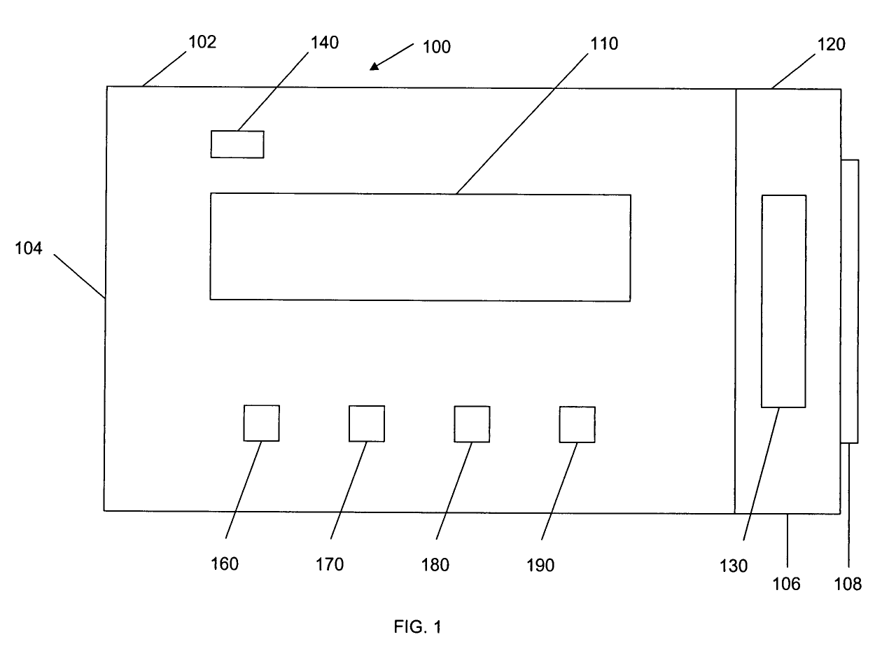

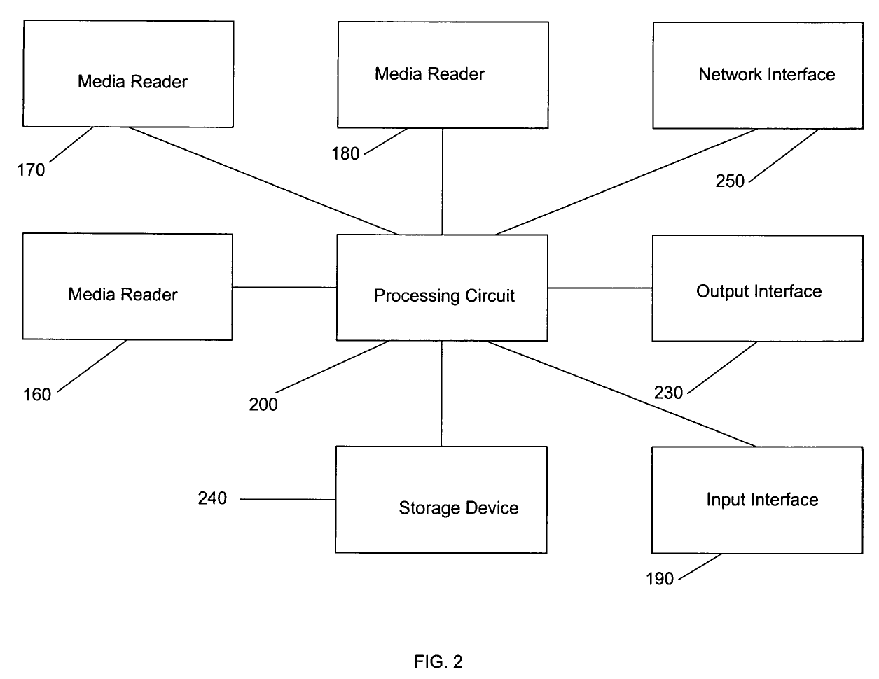

With reference to the FIG. 1 and FIG. 2, a device generally designated 100 may include a media converter 102 and a detachable media player 120. Media converter 102 may include a housing 104 and detachable media player 120 may include a housing 106. Housing 104 and housing 106 are shown as having a rectangular configuration but may have other configurations such as circular and oblong. Housings 104 and 106 may be coupled in a conventional manner. A media converter processing circuit 200 may be disposed within the housing 104 to provide functionality to the media converter 102. The device 100 may be powered by a power line (not shown).

Media converter 102 may include a plurality of media readers 160, 170, and 180. Media readers 160, 170, and 180 may include tape cassette players, CD players, VCRs, DVD players, video camcorders and flash memory device readers. As shown in FIG. 2, media readers 160, 170, and 180 may be coupled to media converter processing circuit 200. Media converter 102 may include a camera 140 coupled to media converter processing circuit through an input interface 190. Camera 140 may be operable to provide digital image files to media converter processing circuit 200.

Media converter processing circuit 200 may be operable to decode received media content from media readers 160, 170, and 180 and may include a plurality of codecs for converting media into digital form. Digital files of the decoded media may be stored in a media converter storage device 240 disposed in housing 104. Digital image files may also be stored in media converter storage device 240.

A media converter network interface 250 coupled to the media converter processing circuit 200 may be disposed in housing 104 and may be operable to couple the media converter processing circuit 200 to a local network or to the Internet. Media converter network interface 250 may include a wired interface such as an Ethernet interface or a wireless interface including a WiFi interface and a WiMax interface. The media converter processing circuit 200 may be operable to convert streaming media into a digital file and to store the digital file in media converter storage device 240.

A media converter output interface 230 may be disposed in housing 104 and may be coupled to the media converter processing circuit 200. The media converter output interface 230 may be operable to provide a media converter display 110 with data. Such data may include which of media readers 160, 170, and 180 are in use and whether conversion of the data is complete.

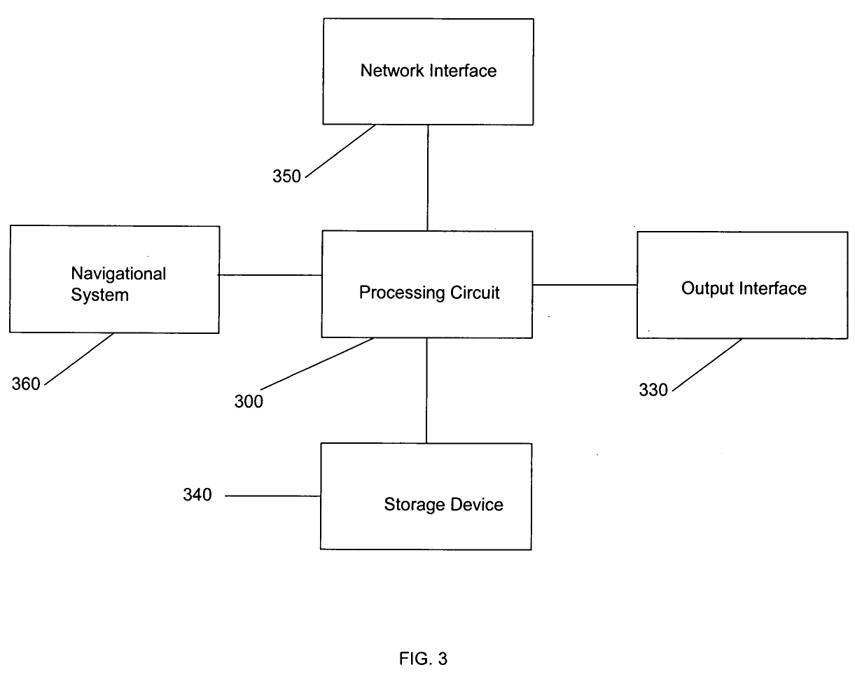

With reference to FIG. 3, detachable media player 120 may include a media player processing circuit 300 coupled to a media player display 130 (FIG. 1). Detachable media player 120 may be electrically coupleable to media converter 102. Media player processing circuit 300 may be operable to play digital files stored in a media player storage device 340 and display video images and photographic images on display 130 coupled to media player output interface 330. Media player 120 may include speakers (not shown) for providing audio.

Media player 120 may include a media player network interface 350 coupled to media player processing circuit 300. Media player network interface 350 may be operable to couple the media player processing circuit 300 to a local network or to the Internet. Media player network interface 350 may include a wired interface such as an Ethernet interface or a wireless interface including a WiFi interface and a WiMax interface. The media player processing circuit 300 may be operable to convert streaming media into a digital file and to store the digital file in media player storage device 340.

Media player 120 may include a telephone 108 coupled to media player output interface 330. Telephone 108 may include a cellular and digital telephone.

Media player 120 may also include a non DVD navigational system 350 coupled to media player processing circuit 300. Navigational system 350 may be operable to display GPS, map information, and driving directions on display 130. Navigational system 350 may be operable to provide radio, TV, and satellite signals to media player processing circuit 300 for processing.

Media converter 102 and media player 120 may be operable to be synchronized with a personal computer (not shown) for the purpose of downloading from the personal computer to the media converter 102 and media player 120 data from the personal computer. Such data may include personal information, addresses, email, and calendar information. Media converter 102 and media player 120 may be synchronized with the personal computer either wirelessly or by means of a wired connection. For this purpose media converter 102 and media player 120 may include a serial port coupled to media converter processing circuit 200 and media player processing circuit 300 (not shown)

In use, a user of device 100 may convert audio cassette tapes, CDs, DVDs, video cassette tapes, and photographs into digital format and store the converted digital files in media converter storage device 240. The stored digital files may then be transferred to the media player storage device 340. The media player 120 may then be taken by the user for use in a vehicle, office, or other location. In this manner, the device 100 of the invention provides the user with a detachable device 120 having stored therein all of the user's media. Additionally, other user information may be downloaded to either media converter 102 or media player 120. Further, streaming media may be played on either media converter 102 or media player 120.

The device of the present invention solves the problems of prior art by providing a device capable of converting multimedia into a digital form and a portable media player capable of playing the converted media.

It should be understood, of course, that the foregoing relates to preferred embodiments of the invention and that modifications may be made without departing from the spirit and scope of the invention as set forth in the following claims.

1. A device for converting media into a digital form comprising:
a media converter including a media reader;
a processing circuit coupled to the media reader, the processing circuit including a codec; and
a storage device coupled to the media reader.

2. The device for converting media into a digital form of claim 1, further comprising a network interface coupled to the processing circuit.

3. The device for converting media into a digital form of claim 2, wherein the network interface comprises a WiFi wireless interface.

4. The device for converting media into a digital form of claim 2, wherein the network interface comprises a WiMax wireless interface.

5. The device for converting media into a digital form of claim 2, wherein the network interface comprises an Ethernet interface.

6. The device for converting media into a digital form of claim 1, wherein the media reader is a cassette tape player.

7. The device for converting media into a digital form of claim 1, wherein the media reader is a CD player.

8. The device for converting media into a digital form of claim 1, wherein the media reader is a DVD player.

9. The device for converting media into a digital form of claim 1, wherein the media reader is a video cassette player.

10. The device for converting media into a digital form of claim 1, further comprising a camera coupled to the processing circuit.

11. The device for converting media into a digital form of claim 1, further comprising a detachable media player detachably and electrically coupled to the media converter.

12. The device for converting media into a digital form of claim 11, wherein the detachable media player comprises a media player storage device coupled to a media player processing circuit.

13. The device for converting media into a digital form of claim 11, wherein the detachable media player comprises a navigation system coupled to the media player processing circuit.

14. The device for converting media into a digital form of claim 11, wherein the detachable media player comprises a media player network interface coupled to the media player processing circuit.

15. The device for converting media into a digital form of claim 11, wherein the detachable media player comprises a telephone coupled to the media player processing circuit.

16. A device for converting media into a digital form comprising:
a housing;
a media reader disposed in the housing;
a processing circuit coupled to the media reader and disposed in the housing, the processing circuit including a codec;
a storage device coupled to the media reader, the storage device disposed in the housing; and
a detachable media player coupled to the housing.

17. The device for converting media into a digital form of claim 16, further comprising a network interface coupled to the processing circuit.

18. The device for converting media into a digital form of claim 17, wherein the network interface comprises a WiFi wireless interface.

19. The device for converting media into a digital form of claim 17, wherein the network interface comprises a WiMax wireless interface.

20. The device for converting media into a digital form of claim 16, wherein the network interface comprises an Ethernet interface.

21. The device for converting media into a digital form of claim 16, wherein the media reader is a cassette tape player.

22. The device for converting media into a digital form of claim 16, wherein the media reader is a CD player.

23. The device for converting media into a digital form of claim 16, wherein the media reader is a DVD player.

24. The device for converting media into a digital form of claim 16, wherein the media reader is a video camcorder.

25. The device for converting media into a digital form of claim 16, wherein the media reader is a video cassette player.

26. The device for converting media into a digital form of claim 16, wherein the detachable media player comprises a media player storage device coupled to a media player processing circuit.

27. The device for converting media into a digital form of claim 16, wherein the detachable media player comprises a navigation system coupled to the media player processing circuit.

28. The device for converting media into a digital form of claim 16, wherein the detachable media player comprises a media player network interface coupled to the media player processing circuit.

29. The device for converting media into a digital form of claim 16, wherein the detachable media player comprises a telephone coupled to the media player processing circuit.

30. The device for converting media into a digital form of claim 16, further comprising a camera coupled to the processing circuit.
